(19) United States
(12) Patent Application Publication
(10) Pub. No.: US 2023/0259932 A1
(43) Pub. Date: Aug. 17, 2023

(54) BLOCKCHAIN-BASED EVENT PROCESSING METHODS AND APPARATUSES

(71) Applicant: Alipay Labs (Singapore) Pte. Ltd., Singapore (SG)

(72) Inventor: Zhe Han, Hangzhou (CN)

(73) Assignee: Alipay Labs (Singapore) Pte. Ltd., Singapore (SG)

(21) Appl. No.: 18/307,374

(22) Filed: Apr. 26, 2023

(30) Foreign Application Priority Data
Apr. 26, 2022 (CN) 202210446603.9

(51) Int. Cl. G06Q 20/38; G06Q 20/40

(52) U.S. Cl. CPC G06Q 20/389; G06Q 20/405

(57) ABSTRACT

An event processing request including an event processing parameter is received from an event initiator. When verification performed on the event processing parameter based on a first smart contract is passed, parsing the event processing parameter based on the first smart contract, determining an event participant, invoking a second smart contract, and determining a current remaining resource of the event participant. When the current remaining resource of the event participant satisfies an event processing condition, invoking the second smart contract based on the first smart contract, and freezing an event resource needed for processing the event processing request in the current remaining resource of the event participant. When a confirmation instruction of the event participant for the event processing parameter of the event processing request is received, invoking the second smart contract based on the first smart contract, deducting the event resource, and completing the event processing request.

### CROSS-REFERENCE TO RELATED APPLICATIONS

This application claims priority to Chinese Patent Application No. 202210446603.9, filed on Apr. 26, 2022, which is hereby incorporated by reference in its entirety.

### TECHNICAL FIELD

One or more embodiments of this specification relate to the field of computer technologies, and in particular, to blockchain-based event processing methods.

### BACKGROUND

In a conventional remittance method, after a user initiates an onchain remittance transaction based on a blockchain, a transaction contract deployed on the blockchain determines a participant related to the transaction based on transaction information submitted by the user. The participant determines, by monitoring information in a block of the blockchain, whether the remittance transaction is a transaction the participant needs to process. If yes, the participant determines whether the remittance transaction is valid and whether the participant has a sufficient limit to process the remittance transaction based on information such as an account number and an amount in the transaction information. Then the participant invokes a transaction contract interface of the blockchain, and feeds back a processing result (whether the remittance transaction is allowed). As such, a processing process of the remittance transaction on the blockchain is advanced.

However, in this method, whether an account in the remittance transaction is valid, whether a limit of the amount of the account is sufficient, etc. need to be determined and fed back offchain by the participant, which is equivalent to processing by a centralized system. The transaction contract on the blockchain can process the remittance transaction only after receiving the feedback result from the participant. Therefore, the timeliness of the remittance transaction depends on the offchain processing speed of the participant, and the processing timeliness cannot be ensured.

### SUMMARY

In view of this, one or more embodiments of this specification provide blockchain-based event processing methods. One or more embodiments of this specification also relate to blockchain-based event processing apparatuses, computing devices, computer-readable storage mediums, and computer programs, to reduce technical disadvantages in the existing technology.

According to a first aspect of one or more embodiments of this specification, a blockchain-based event processing method is provided. The method is applied to a blockchain node, a first smart contract for performing event processing and a second smart contract for managing participant resources are deployed on the blockchain node, and the method includes the following:

An event processing request initiated by an event initiator is received. The event processing request includes an event processing parameter.

When verification performed on the event processing parameter based on the first smart contract is passed, the event processing parameter is parsed based on the first smart contract, an event participant is determined, the second smart contract is invoked, and a current remaining resource of the event participant is determined.

When the current remaining resource of the event participant satisfies an event processing condition, the second smart contract is invoked based on the first smart contract, and an event resource needed for processing the event processing request in the current remaining resource of the event participant is frozen.

When a confirmation instruction of the event participant for the event processing parameter of the event processing request is received, the second smart contract is invoked based on the first smart contract, the event resource is deducted, and the event processing request is completed.

According to a second aspect of one or more embodiments of this specification, a blockchain-based event processing apparatus is provided. The apparatus is applied to a blockchain node, a first smart contract for performing event processing and a second smart contract for managing participant resources are deployed on the blockchain node, and the apparatus includes: a request receiving module, configured to receive an event processing request initiated by an event initiator, where the event processing request includes an event processing parameter; a resource determining module, configured to parse, when verification performed on the event processing parameter based on the first smart contract is passed, the event processing parameter based on the first smart contract, determine an event participant, invoke the second smart contract, and determine a current remaining resource of the event participant; a resource freezing module, configured to invoke, when the current remaining resource of the event participant satisfies an event processing condition, the second smart contract based on the first smart contract, and freeze an event resource needed for processing the event processing request in the current remaining resource of the event participant; and an event processing module, configured to invoke, when a confirmation instruction of the event participant for the event processing parameter of the event processing request is received, the second smart contract based on the first smart contract, deduct the event resource, and complete the event processing request.

According to a third aspect of one or more embodiments of this specification, a computing device is provided. The computing device includes: a memory and a processor.

The memory is configured to store computer-executable instructions, the processor is configured to execute the computer-executable instructions, and when the computer-executable instructions are executed by the processor, the steps of the previously described blockchain-based event processing method are implemented.

According to a fourth aspect of one or more embodiments of this specification, a computer-readable storage medium is provided. The computer-readable storage medium stores computer-executable instructions, and when the instructions are executed by a processor, the steps of the previously described blockchain-based event processing method are implemented.

According to a fifth aspect of one or more embodiments of this specification, a computer program is provided. When the computer program is executed on a computer, the computer is enabled to perform the steps of the previously described blockchain-based event processing method.

One or more embodiments of this specification implement a blockchain-based event processing method. The method is applied to a blockchain node, a first smart contract for performing event processing and a second smart contract for managing participant resources are deployed on the blockchain node, and the method includes the following: An event processing request initiated by an event initiator is received. The event processing request includes an event processing parameter. When verification performed on the event processing parameter based on the first smart contract is passed, the event processing parameter is parsed based on the first smart contract, an event participant is determined, the second smart contract is invoked, and a current remaining resource of the event participant is determined. When the current remaining resource of the event participant satisfies an event processing condition, the second smart contract is invoked based on the first smart contract, and an event resource needed for processing the event processing request in the current remaining resource of the event participant is frozen. When a confirmation instruction of the event participant for the event processing parameter of the event processing request is received, the second smart contract is invoked based on the first smart contract, the event resource is deducted, and the event processing request is completed.

Specifically, according to the blockchain-based event processing method, the first smart contract and the second smart contract are automatically bound, and the event processing request on the blockchain is automatically advanced by using the first smart contract and the second smart contract, to process the event processing request. In addition, the validity of the event participant and limit information of the event participant are automatically analyzed on the blockchain, so that the event processing request can be correspondingly processed in a timely manner based on an analysis result, the event processing speed can be increased, and the processing timeliness can be ensured.

### BRIEF DESCRIPTION OF DRAWINGS

FIG. 1 is a flowchart illustrating limit management applied to a blockchain fund transaction, according to one or more embodiments of this specification;

FIG. 2 is a diagram illustrating a system structure that a blockchain-based event processing method is specifically applied, according to one or more embodiments of this specification;

FIG. 3 is a flowchart illustrating a blockchain-based event processing method, according to one or more embodiments of this specification;

FIG. 4 is a flowchart illustrating update of limit information on a blockchain in a blockchain-based event processing method, according to one or more embodiments of this specification;

FIG. 5 is a flowchart illustrating a processing process of a blockchain-based event processing method, according to one or more embodiments of this specification;

FIG. 6 is a schematic diagram illustrating a structure of a blockchain-based event processing apparatus, according to one or more embodiments of this specification; and

FIG. 7 is a block diagram illustrating a structure of a computing device according to one or more embodiments of this specification.

### DESCRIPTION OF EMBODIMENTS

In the following descriptions, many specific details are set forth to facilitate a thorough understanding of this specification. This specification, however, can be embodied in many other ways than those described herein, and a person skilled in the art can make similar generalization without departing from the spirit of this specification, and therefore this specification is not limited to the specific implementations disclosed below.

Terms used in one or more embodiments of this specification are merely used to describe specific embodiments, and are not intended to limit the one or more embodiments of this specification. The terms “a” and “the” of singular forms used in one or more embodiments of this specification and the appended claims are also intended to include plural forms, unless otherwise specified in the context clearly. It should be further understood that the term “and/or” used in one or more embodiments of this specification indicates and includes any or all possible combinations of one or more associated listed items.

It should be understood that although terms such as “first” and “second” may be used in one or more embodiments of this specification to describe various types of information, the information is not limited to these terms. These terms are merely used to differentiate between information of the same type. For example, without departing from the scope of one or more embodiments of this specification, first can also be referred to as second, and similarly, second can be referred to as first. Depending on the context, for example, the word “if” used here can be explained as “while”, “when”, or “in response to determining”.

First, the nouns involved in one or more embodiments of this specification are explained.

Limit: A limit describes the total amount of funds of a transaction that can be initiated through a certain channel within a certain time period. At the end of the time period, the limit is refreshed.

Initiator: An initiator refers to a user who needs to transfer funds, and is a party initiating a transaction.

Contract: A contract is a smart contract in a blockchain instead of a commercial contract.

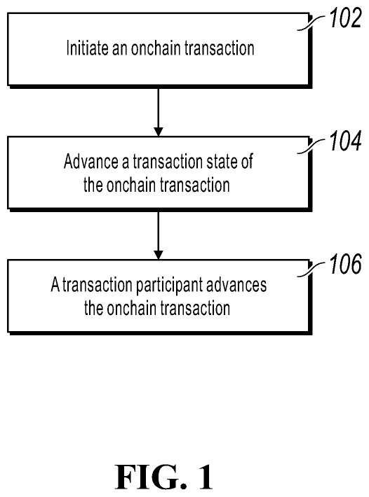

FIG. 1 is a flowchart illustrating limit management applied to a blockchain fund transaction, according to one or more embodiments of this specification. The method specifically includes the following steps.

Step 102: Initiate an onchain transaction.

Specifically, the initiating an onchain transaction can mean that a user invokes a transaction contract deployed on a blockchain node to initiate an onchain remittance transaction.

A plurality of parties are involved in the fund transaction scenario of the blockchain.

Step 104: Advance a transaction state of the onchain transaction.

Specifically, that the onchain transaction advances a transaction state can mean that the blockchain node parses a transaction parameter included in the remittance transaction initiated by the user by executing the transaction contract, to determine participants involved in the remittance transaction. In other words, the transaction contract deployed on the blockchain automatically advances the transaction state based on the transaction parameter.

The transaction parameter includes but is not limited to an account number involved in the transaction, the participants (for example, a bank), a transaction amount related to each participant, etc.

Step 106: The transaction participants advance the onchain transaction.

Specifically, that the transaction participants advance the onchain transaction can be understood as follows: Each participant determines, by monitoring information in a block of the blockchain, that the remittance transaction is a transaction the participant needs to process. The participant determines whether an account number is valid and whether the participant has a sufficient remaining limit based on information such as the account number and the amount in the transaction parameter of the remittance transaction. Then the participant invokes a transaction contract interface of the blockchain, and feeds back a processing result (to be specific, whether the transaction is allowed), thereby advancing the transaction on the blockchain.

The blockchain node automatically reaches a final state based on the transaction contract deployed on the blockchain node after the participants feed back processing results.

However, the method has the following disadvantages: Whether the account number in the remittance transaction is valid, whether the limit is sufficient for the transaction amount, etc. need to be determined offchain by the participant, and an excess transaction can be processed only after offchain feedback results of the participants are received. This is equivalent to processing performed by a centralized system. In addition, the processing timeliness cannot be ensured.

Based on the previous descriptions, this specification provides blockchain-based event processing methods. This specification also relates to blockchain-based event processing apparatuses, computing devices, and computer-readable storage mediums. The blockchain-based event processing methods, the blockchain-based event processing apparatuses, the computing devices, and the computer-readable storage mediums are described in detail one by one in the following embodiments.

Before the blockchain-based event processing method is described in detail, a system structure that the blockchain-based event processing method is applied is described.

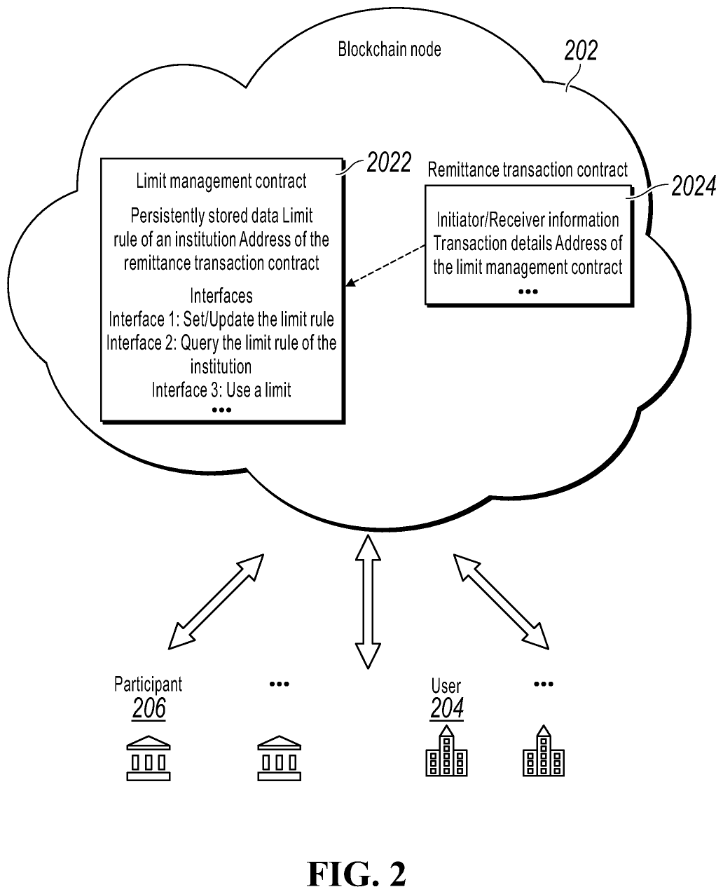

FIG. 2 is a diagram illustrating a system structure that a blockchain-based event processing method is specifically applied, according to one or more embodiments of this specification.

Specifically, the diagram of the system architecture in FIG. 2 includes a blockchain node 202, a limit management contract 2022 deployed on the blockchain node 202, a remittance transaction contract 2024, a user 204, and participants 206 (for example, a bank).

Each participant 206 (for example, the bank and another institution that needs to participate in the transaction) communicates with a blockchain network (the blockchain node), and does not need to directly communicate with other institutions. In general, the another institution that participates in the transaction can be understood as the payer, which can be a subject within the bank, an externally associated bank, etc.

The limit management contract 2022 deployed on the blockchain network includes at least three interfaces such as update, query, and use interfaces, and persistently stores a limit rule of each participant. An onchain account of each participant can invoke the update interface of the limit management contract 2022 to set a limit rule of a channel of the participant (for example, what is the limit for each currency and when will the limit be refreshed/reset). An onchain account of another institution can query a remaining limit of any institution (participant) through the query interface of the limit management contract 2022. Moreover, an address of the remittance transaction contract 2024 is stored inside the limit management contract 2022, so that other contracts and users can be prevented from invoking the contract to complete authentication.

Persistently stored limit rules in the limit management contract 2022 are shown in Table 1.

TABLE 1
Institution limit

| Identity/address of | |
|---|---|
| a blockchain account | Limit rule |
| Identity/address of | Total limit: 1000 yuan; used limit: 10 yuan; |
| a blockchain account | limit refresh time: 9:00; limit refresh rule: |
| corresponding to | refresh every day |
| institution 1 | |
| Identity/address of | Total limit: 2000 yuan; used limit: 10 yuan; |
| a blockchain account | limit refresh time: 8:00; limit refresh rule: |
| corresponding to | refresh every Sunday |
| institution 2 | Total limit: 2000 yuan; used limit: 10 yuan; |
| | limit refresh time: 7:00; limit refresh rule: |
| | refresh every day |
| . . . | . . . |

As shown in Table 1, the persistently stored limit rules in the limit management contract 2022 include limits, used limits, refresh time, etc. of different currencies of the institutions.

The remittance transaction contract 2024 deployed on the blockchain network includes the address of the limit management contract 2022. When initiating a remittance transaction, the user can query whether the participant has a corresponding limit. The remittance transaction contract 2024 further includes initiator/receiver information, transaction details (for example, a transaction state), etc.

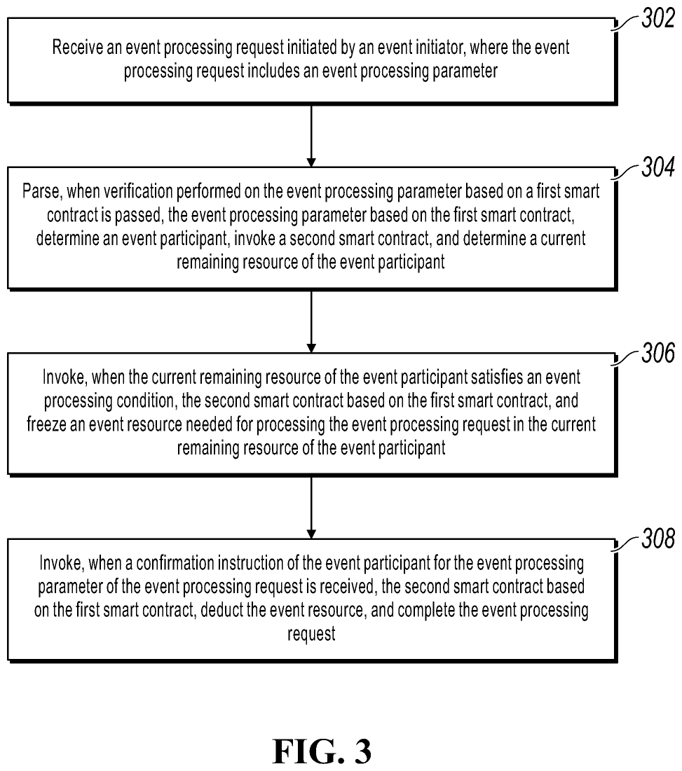

FIG. 3 is a flowchart illustrating a blockchain-based event processing method, according to one or more embodiments of this specification. The blockchain-based event processing method is applied to a blockchain node, a first smart contract for performing event processing and a second smart contract for managing participant resources are deployed on the blockchain node, and the method specifically includes the following steps.

Step 302: Receive an event processing request initiated by an event initiator, where the event processing request includes an event processing parameter.

Specifically, the blockchain-based event processing method provided in the embodiments of this specification is applied to the blockchain node in the diagram of the system structure in FIG. 2, and in a remittance transaction scenario, the first smart contract can be understood as the previously described remittance transaction contract 2024, and the second smart contract can be understood as the previously described limit management contract 2022.

The event initiator can be understood as an initiating user, and the event can be understood as a transaction (for example, a remittance transaction or a fund transfer transaction). When the event initiator is understood as an initiating user, and the event is understood as a remittance transaction, the receiving an event processing request initiated by an event initiator can mean that the blockchain node receives a transaction processing request initiated by the initiating user.

When the event is a transaction, the event processing parameter can be understood as a transaction processing parameter, for example, information such as an onchain account corresponding to the initiating user, a transaction participant involved, an onchain account of each transaction participant, a transaction amount related to each transaction participant, and a currency.

In an example that the event initiator is an initiating user and the event is a transaction, the receiving an event processing request initiated by an event initiator can be understood as follows: The initiating user invokes the first smart contract (for example, a remittance transaction contract) deployed on the blockchain node to initiate a transaction processing request when the initiating user needs to initiate a remittance transaction or a fund transfer transaction. The transaction processing request includes a transaction processing parameter.

Step 304: Parse, when verification performed on the event processing parameter based on the first smart contract is passed, the event processing parameter based on the first smart contract, determine an event participant, invoke the second smart contract, and determine a current remaining resource of the event participant.

Specifically, the parsing, when verification performed on the event processing parameter based on the first smart contract is passed, the event processing parameter based on the first smart contract, determining an event participant, invoking the second smart contract, and determining a current remaining resource of the event participant includes: verifying the event processing parameter based on the first smart contract; parsing, when the verification is passed, the event processing parameter based on the first smart contract, and determining at least one event participant for processing the event processing request; and invoking the second smart contract based on the first smart contract, and determining a current remaining resource of each event participant.

During specification implementation, for ease of understanding, the following embodiments are described in detail by using an example that the blockchain-based event processing method provided in the embodiments of this specification is applied to the blockchain node in the diagram of the system structure in FIG. 2, the first smart contract is the remittance transaction contract 2024, the second smart contract is the limit management contract 2022, and the event is a remittance transaction event.

Continuing with the previous example, after receiving the event processing request, the blockchain node executes processing logic of the remittance transaction contract to verify (for example, perform authentication and parameter verification on) the event processing parameter included in the event processing request, for example, to verify whether the transaction initiator (the initiating user) is a valid onchain user and whether transaction parameters are complete (information such as an onchain account and currency information corresponding to a receiving bank/an initiating bank needs to be specified). When the verification is passed, the blockchain node executes the processing logic of the remittance transaction contract, parses the event processing parameter, and determines at least one event participant for processing the event processing request from the event processing parameter. In other words, after the previously described verification is passed, the blockchain node can execute the processing logic of the remittance transaction contract to extract participating institutions involved in the current remittance transaction.

In addition, the blockchain node executes the remittance transaction contract and automatically invokes the limit management contract to respectively query limit information related to the participating institutions involved in the current remittance transaction.

According to the blockchain-based event processing method provided in the embodiments of this application, the remittance transaction contract can be invoked to request to automatically complete authentication and parameter verification requested by the remittance transaction, without needing the event participant (namely, the transaction participant or the participating institution) to perform offchain processing, thereby greatly improving the processing efficiency of the remittance transaction.

In addition, a transaction state of the whole remittance transaction process is further maintained in the remittance transaction contract, so that the event initiator, the event participant, etc. can subsequently query the transaction state of the whole remittance transaction on the blockchain, without querying the centralized system, thereby implementing decentralization. A specific implementation is described as follows:

After the at least one event participant for processing the event processing request is determined, the method further includes the following:

An event state of the first smart contract is updated to an event processing parameter confirmation complete state.

To be specific, after the previously described verification is passed, the blockchain node changes the transaction state in the remittance transaction contract of the blockchain node while executing the processing logic of the remittance transaction contract to extract the participating institutions involved in the current remittance transaction, in other words, changes the transaction state in the remittance transaction contract to a transaction processing parameter confirmation complete state.

Step 306: Invoke, when the current remaining resource of the event participant satisfies an event processing condition, the second smart contract based on the first smart contract, and freeze an event resource needed for processing the event processing request in the current remaining resource of the event participant.

Specifically, the invoking, when the current remaining resource of the event participant satisfies an event processing condition, the second smart contract based on the first smart contract, and freezing an event resource needed for processing the event processing request in the current remaining resource of the event participant includes: determining an event processing resource for processing the event processing request by each event participant based on the event processing parameter; and invoking, when it is determined that a current remaining resource of each event participant is greater than or equal to the event processing resource, the second smart contract based on the first smart contract, and freezing an event resource needed for processing the event processing request by each event participant in the current remaining resource of each event participant.

Continuing with the previous example, a transaction limit needed for processing the transaction processing request by each transaction participant is determined based on the transaction processing parameter. When determining that a current remaining limit of each transaction participant is greater than or equal to a transaction limit needed for processing the transaction processing request by the transaction participant, the blockchain node executes the processing logic of the remittance transaction contract, invokes the limit management contract, and freezes the transaction limit needed for processing the transaction processing request by the transaction participant in the current remaining limit of the transaction participant.

Generally, a remittance transaction involving a plurality of transaction participants involves at least two participating banks: a paying bank and a receiving bank, and possibly other intermediate banks. The limit management contract is invoked for each bank to query a remaining limit of the bank, to be specific, query whether a transaction participant currently has a sufficient remaining limit and whether the remaining limit is greater than or equal to a transaction limit needed for processing the transaction processing request by the bank, in other words, whether the remaining limit can be sufficient to complete the current transaction processing request.

A corresponding limit is deducted for each transaction participant when the limit management contract is invoked to determine that there is no problem with current remaining limits of the transaction participants. In other words, the limit withdrawing method is to execute the remittance transaction contract, invoke a limit use interface of the limit management contract, and freeze a corresponding transaction limit from the current remaining limit of each transaction participant.

After the limit withdrawing is completed, the transaction state in the remittance transaction contract can be changed, in other words, the transaction state in the remittance transaction contract is advanced to “waiting for the transaction participant to confirm the current transaction”. A specific implementation is described as follows:

After the second smart contract is invoked based on the first smart contract, and an event resource needed for processing the event processing request by each event participant in the current remaining resource of each event participant is frozen, the method further includes the following:

An event state of the first smart contract is updated to a state of waiting for each event participant to confirm and process the event processing request.

According to the blockchain-based event processing method provided in the embodiments of this specification, the remittance transaction contract can be executed, the limit management contract can be automatically invoked, and limit information related to the transaction participants involved in the current transaction processing request can be respectively queried to determine whether each transaction participant has a sufficient remaining limit to complete the current transaction processing request, without needing each transaction participant to return the result after determining the limit offchain, thereby improving the processing timeliness of the current transaction processing request.

When a current remaining limit of a certain transaction participant is insufficient, the current transaction processing can be immediately closed without waiting for feedback from the transaction participant, thereby ensuring the efficiency and timeliness of the current transaction processing. A specific implementation is described as follows:

After the event processing resource for processing the event processing request by the event participant is determined based on the event processing parameter, the method further includes the following:

When it is determined that a current remaining resource of any event participant is less than the event processing resource, an event state of the first smart contract is updated to an event processing failure state, and the event processing request is ended.

In practice, when it is determined that a current remaining resources of any transaction participant is insufficient, in other words, cannot complete the current transaction processing request, the event state of the remittance transaction contract is immediately updated to a current transaction processing failure state, in other words, the current transaction processing state is set to a failed-and-closed state, and the current transaction processing request is ended.

As such, when a limit of a certain transaction participant is insufficient, the current transaction processing request can be processed directly onchain without waiting for a feedback result from each transaction participant, so that the processing speed and efficiency are greatly improved.

Step 308: Invoke, when a confirmation instruction of the event participant for the event processing parameter of the event processing request is received, the second smart contract based on the first smart contract, deduct the event resource, and complete the event processing request.

Continuing with the previous example, the confirmation instruction of the event participant for the event processing parameter of the event processing request can be understood as a confirmation instruction of the transaction participant for the transaction processing parameter (for example, a deducted limit and an account of the transaction initiator) of the event processing request.

In practice, each transaction participant monitors a block event on the blockchain, and parses the content in the blockchain. When a new transaction related to the transaction participant is triggered, the transaction participant obtains parameter information of the current transaction by querying the blockchain contract content. Subsequently, the transaction participant can send a confirmation instruction or an instruction indicating that the current transaction is incorrect based on the obtained parameter information of the current transaction. A specific implementation is described as follows:

Before the second smart contract is invoked based on the first smart contract, the event resource is deducted, and the event processing request is completed, the method further includes the following:

An event query request sent by the event participant for the event processing request is received, and an event processing parameter for processing the event processing request is returned to the event participant based on the event query request.

The event query request is sent by the event participant after the event participant monitors and parses block content of the blockchain node to determine the corresponding event processing request.

Specifically, the block event can be understood as data of the blockchain, namely, a criterion/flag eventually stored on the blockchain permanently. The blockchain is a chain of data, which has been previously stored in blocks. Only subsequent blocks can be changed but the previous blockchain cannot be changed. The content of the block can be any text. The content is usually pre-agreed. For example, both a request packet for executing a contract and a contract execution result are put into the block. As long as blockchain nodes have a consistent contract execution result, the result is incorporated into the block. Parsing the content of the blockchain can be understood as checking whether a request packet is consistent with transaction information submitted by the original user, checking the execution result, and checking whether the remittance transaction contract is sent by the corresponding user when the request is correctly verified, checking whether the contract state of the remittance transaction contract is advanced to an expected state after the remittance transaction contract is executed, etc.

Continuing with the previous example, the blockchain node receives a transaction query request sent by each transaction participant for the current transaction processing request, and sends a transaction processing parameter, for example, a deducted limit and an onchain account number of the transaction initiator, of the transaction processing request to each transaction participant based on the transaction query request.

When receiving a confirmation instruction returned by any transaction participant for the transaction processing request, the blockchain node queries and determines whether the current transaction processing request involves only the transaction participant or involves a plurality of transaction participants. When the transaction processing request involves a plurality of transaction participants, the blockchain node queries and determines whether each transaction participant returns a confirmation instruction for the current transaction processing request. If yes, the blockchain node executes the remittance transaction contract, invokes the limit management contract, and actually deducts the frozen transaction limit of each transaction participant, to complete the current transaction processing request. A specific implementation is described as follows:

The invoking, when a confirmation instruction of the event participant for the event processing parameter of the event processing request is received, the second smart contract based on the first smart contract, deducting the event resource, and completing the event processing request includes: querying and determining, when a confirmation instruction of any event participant for the event processing parameter of the event processing request is received, whether each event participant sends a confirmation instruction for the event processing parameter; and if yes, invoking the second smart contract based on the first smart contract, deducting a frozen event resource of each event participant, and completing the event processing request.

Continuing with the previous example, when receiving confirmation information returned by any transaction participant based on the remittance transaction contract, the blockchain node triggers automatic processing logic, and queries whether each transaction participant involved in the current transaction processing request confirms the transaction. If each transaction participant confirms the transaction, the blockchain node automatically advances a current transaction state to a final state (in other words, the current transaction processing succeeds). A specific implementation is described as follows:

After the event processing request is completed, the method further includes the following:

An event state of the first smart contract is updated to an event processing request processing success state.

Based on the event processing request processing success state, it can be determined that the current event processing request is completed, in other words, the current event processing request succeeds.

When the contract state of the remittance transaction contract is advanced to the final state, the limit management contract can be invoked, and the actual use of the frozen transaction limit of each transaction participant in the previously described embodiment is confirmed, to complete the current transaction processing request.

Because of a contract characteristic of the blockchain, it can be ensured that limit update of each transaction participant and transaction update must succeed or fail at the same time, and no inconsistency occurs.

In addition, after the current transaction processing request is completed, both the transaction initiator and the transaction participant can confirm that the current transaction has reached the final state through pull block parsing, etc., so that the decentralized management where the centralized system does not need to be queried is implemented. A specific implementation is described as follows:

After the event processing request is completed, the method further includes the following:

A current processing state query request sent by the event initiator and/or the event participant for the event processing request is received, and a current processing state for the event processing request is returned to the event initiator and/or the event participant based on the current processing state query request.

Continuing with the previous example, after the current transaction processing request is completed, a query request sent by the transaction initiator and/or the transaction participant for the current processing state of the current transaction processing request can be received. The current processing state, for example, the final state or another state, for the current transaction processing request can be sent to the transaction initiator and/or the transaction participant based on the query request for the current processing state.

In addition, after the current transaction processing request is completed, the blockchain node can automatically refresh a total limit of each event participant based on a limit update rule of each event participant in the limit management contract, without participation of the event participant, thereby implementing automatic limit management of each event participant and improving user experience. A specific implementation is described as follows:

After the event processing request is completed, the method further includes the following:

An update interface of the second smart contract is invoked, and the current remaining resource of each event participant is updated based on a resource update rule of each event participant in the second smart contract.

When the second smart contract is understood as the limit management contract, the resource update rule in the second smart contract can be understood as a limit rule in the limit management contract, as shown in Table 1. Details are omitted for simplicity.

Specifically, the blockchain node invokes an update interface of the limit management contract, and automatically updates the current remaining limit of each transaction participant based on the limit rule of each transaction participant that is set in the limit management contract. For example, a limit of institution 1 is refreshed to a total limit at 9 o'clock every day.

In addition, the transaction participant can further invoke the update interface of the limit management contract deployed on the blockchain node in real time to update the limit rule of the transaction participant. A specific implementation is described as follows:

The blockchain-based event processing method further includes the following:

A rule update request initiated by the event participant by invoking the update interface of the second smart contract is received. The rule update request includes a rule update parameter.

The resource update rule is updated based on the rule update parameter when verification performed on the rule update parameter based on the second smart contract is passed.

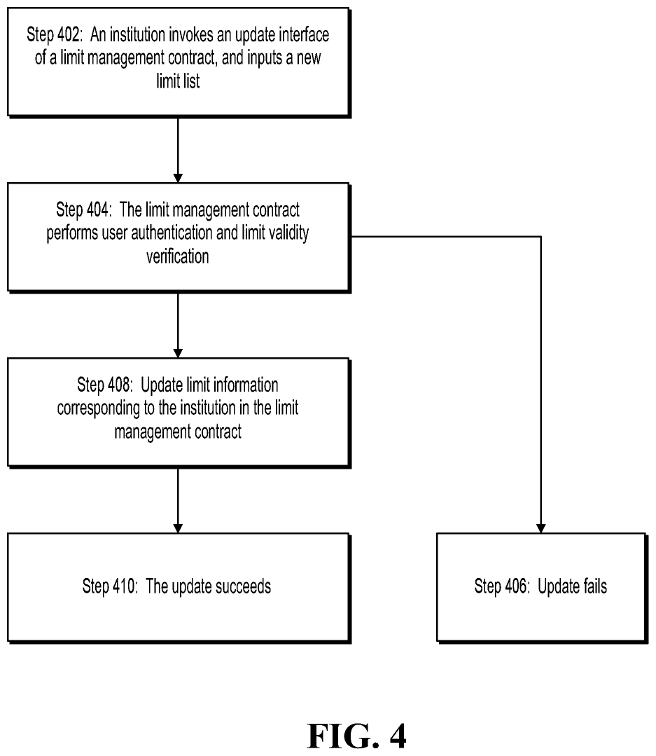

Specifically, continuing with the previous example, the event participant invokes the update interface of the second smart contract, and updates the resource update rule based on a method shown in FIG. 4.

FIG. 4 is a flowchart illustrating update of limit information on a blockchain in a blockchain-based event processing method, according to one or more embodiments of this specification.

Step 402: An institution invokes an update interface of a limit management contract, and inputs a new limit list.

The institution can be understood as a transaction participant. The limit list includes a limit configuration of the institution, for example, an updated limit rule.

Step 404: The limit management contract performs user authentication and limit validity verification, where if the verification is passed, step 406 is performed, or if the verification fails, step 408 is performed.

Specifically, that the limit management contract performs user authentication and limit validity verification can be understood as follows: A blockchain node executes processing logic of the limit management contract, first verifies an institution account (for example, determines whether the account is an onchain account or determine whether the institution is a bank institution), and then verifies limit information input by the institution (for example, whether the amount, currency, and update time in the limit list are valid) after the verification is passed. If both permission verification (user authentication verification) and remittance format verification (namely, limit validity verification) are passed, step 406 is performed; otherwise, step 408 is performed.

Step 406: Update fails.

To be specific, if the authentication fails or the limit is invalid, the current limit information update fails.

Step 408: Update limit information corresponding to the institution in the limit management contract.

To be specific, when the authentication succeeds and the limit is valid, the limit information corresponding to the institution in the limit management contract is updated based on the new limit list.

Step 410: The update succeeds.

To be specific, the limit information corresponding to the institution in the limit management contract is successfully updated based on the new limit list succeeds.

In practice, with the rapid growth of blockchain fund transfer needs, due to the real-time characteristic, limit of blockchain transfer from different channels is restricted, and a perfect limit management and control capability can increase the transaction success rate. Moreover, the limit of the channel is suitable for being implemented on the blockchain, the limit usually does not change, and a remaining limit is directly associated with whether the transaction is successful or not. In the embodiments of this application, the limit and an onchain transaction are bound, so that the whole process of the transaction can be automatically implemented, and the limit management and control capability is implemented onchain, so that the reliability of the system can be improved, and supervision and tracking capabilities are improved.

The limit of the transaction is suitable for onchain management because the limit that the channel can use does not change frequently and configuration costs are low. In addition, the increase/decrease of the limit is closely related to the transaction (the limit is correspondingly deducted when the transaction succeeds, and the limit is refreshed/restored at specified time), and can be associated with an onchain transaction contract, thereby facilitating the automation of the whole fund transfer process. If the limit is insufficient, the onchain transaction can be automatically ended, so that the timeliness is prevented from being affected because the onchain transaction is stuck. In the embodiments of this specification, managing the fund transfer limit on the blockchain can avoid the reliability and security problems of centralized management and control, avoid the black box problem of the internal state when the centralized system manages the transaction limit, and further make it convenient to track limit usage of the channel and perform operations such as transaction analysis after limit management and control are implemented onchain.

According to the blockchain-based event processing methods provided in the embodiments of this specification, a first smart contract and a second smart contract are automatically bound, and an event processing request on the blockchain is automatically advanced by using the first smart contract and the second smart contract, to process the event processing request. In addition, the validity of an event participant and limit information of the event participant are automatically analyzed on the blockchain, so that the event processing request can be correspondingly processed in a timely manner based on an analysis result, the event processing speed can be increased, and the processing timeliness can be ensured.

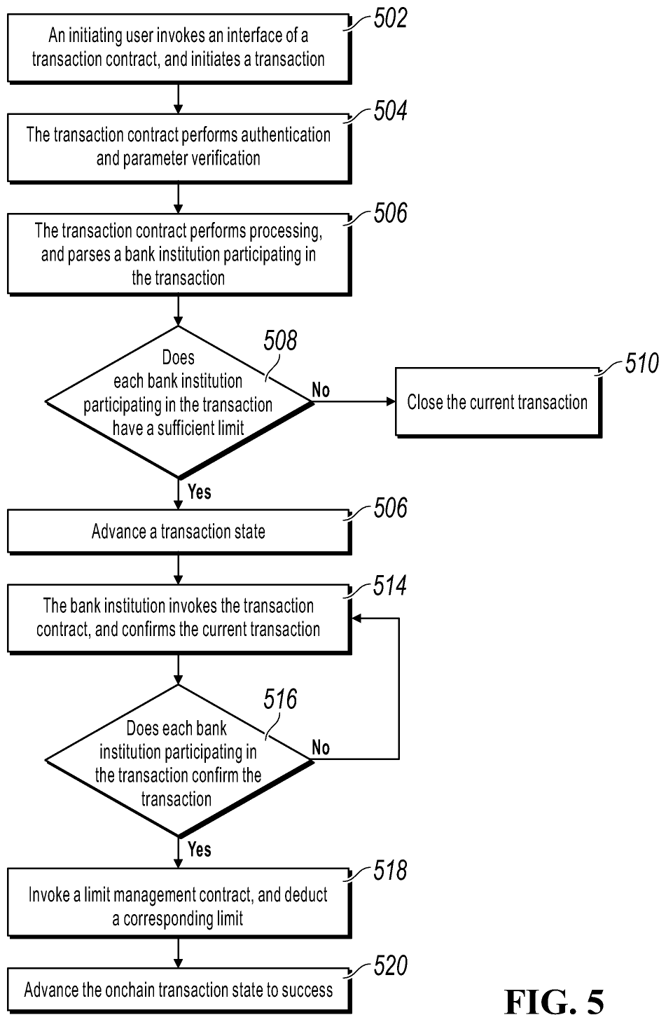

With reference to FIG. 5, the following further describes the blockchain-based event processing method provided in this specification by using an example that the blockchain-based event processing method is applied to a remittance transaction scenario. FIG. 5 is a flowchart illustrating a processing process of a blockchain-based event processing method, according to one or more embodiments of this specification. The method specifically includes the following steps.

Step 502: An initiating user invokes an interface of a transaction contract, and initiates a transaction.

Specifically, that an initiating user invokes an interface of a transaction contract, and initiates a transaction can be understood as follows: When the initiating user needs to initiate a remittance transaction or a fund transfer transaction, the initiating user invokes a remittance transaction contract, and initiates the transaction.

Step 504: The transaction contract performs authentication and parameter verification.

Specifically, that the transaction contract performs authentication and parameter verification can be understood as follows: A blockchain node executes processing logic of the remittance transaction contract, and performs authentication and parameter verification on the transaction, to verify whether the initiating user has a valid onchain account and whether transaction parameters are complete (information such as onchain accounts and currencies corresponding to an initiating bank and a receiving bank needs to be specified).

Step 506: The transaction contract performs processing, and parses a bank institution participating in the transaction.

Specifically, that the transaction contract performs processing, and parses a bank institution participating in the transaction can be understood as follows: When the previously described verification is passed, the blockchain node executes the processing logic of the remittance transaction contract, and extracts the bank institution involved in the transaction from the transaction parameters of the transaction.

Step 508: Invoke a limit management contract, and query whether each bank institution participating in the transaction has a sufficient limit, where if yes, step 512 is performed, or if no, step 510 is performed.

Specifically, the invoking a limit management contract, and querying whether each bank institution participating in the transaction has a sufficient limit can be understood as follows: The blockchain node executes the processing logic of the remittance transaction contract, automatically invokes the limit management contract, respectively queries limit information of the banks related to the transaction, and queries the bank institutions to determine whether a current remaining limit of each bank institution is greater than a current transaction amount (in other words, whether the current remaining limit is sufficient to complete the current transaction). If yes, step 512 is performed, or if no, step 510 is performed.

Step 510: Close the current transaction.

Step 512: Advance a transaction state.

Specifically, the advancing a transaction state can be understood as follows: The blockchain node executes the processing logic of the remittance transaction contract, automatically invokes a limit use interface of the limit management contract, performs limit withdrawing for each bank institution, and advances a state of the remittance transaction contract (for example, to “waiting for the bank institution to confirm the current transaction”) after the deduction is completed.

Step 514: The bank institution invokes the transaction contract, and confirms the current transaction.

Specifically, that the bank institution invokes the transaction contract, and confirms the current transaction can be understood as follows: The bank institution participating in the transaction knows that a new transaction of the bank institution is triggered by monitoring a block event on the blockchain and parsing the content in the block, and can know parameter information of the current transaction by querying the content of the blockchain contract. After determining that the transaction processing is correct offchain, the bank institution invokes a confirm interface of the remittance transaction contract, and confirms the transaction.

Step 516: Determine whether each bank institution participating in the transaction confirms the transaction, where if yes, step 518 is performed, or if no, step 514 is performed.

Specifically, the determining whether each bank institution participating in the transaction confirms the transaction can be understood as follows: After receiving confirmation information returned by any bank institution participating in the transaction, the remittance transaction contract triggers the automatic processing logic, and queries whether each bank institution of the current transaction confirms the transaction. If each bank institution of the current transaction confirms the transaction, the current transaction state is automatically advanced to a final state (success), in other words, step 518 is performed, or if there is a bank institution that does not confirm the transaction, step 514 is performed to wait for confirmation from other bank institutions.

Step 518: Invoke the limit management contract, and deduct a corresponding limit.

Specifically, the invoking the limit management contract, and deducting a corresponding limit can be understood as invoking the limit management contract to deduct the corresponding limit from each bank institution to complete the current transaction.

Step 520: Advance the onchain transaction state to success.

After the limit management contract is invoked to deduct the corresponding limit, the onchain transaction state in the remittance transaction contract is recommended to success, in other words, the current transaction is successfully completed.

According to the blockchain-based event processing method provided in the embodiments of this application, the method for managing a transaction limit onchain is provided, and the limit is further associated with automatic advancement of a transaction state. For some exceptions (for example, the limit of the participant is used up and there is no limit), the transaction can be automatically closed without waiting for a participating bank and the blockchain to conduct the transaction, while ensuring that these closed transactions are not tampered with, and are not affected by malicious actions by a centralized system. In other words, this method provides a method for automatically binding onchain remittance management and an onchain transaction contract, so that onchain remittance information can be automatically followed to advance a transaction state, an institution and limit information associated with the transaction can be automatically analyzed, and an invalid transaction can be terminated in advance, so that the transaction speed and reliability of the transaction are improved.

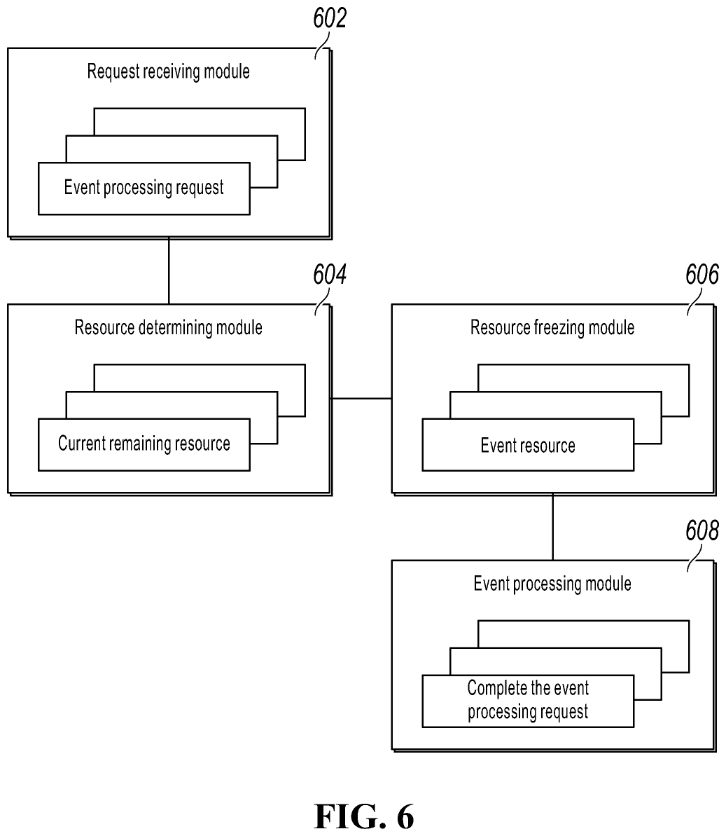

Corresponding to the previously described method embodiments, this specification further provides embodiments of blockchain-based event processing apparatuses. FIG. 6 is a schematic diagram illustrating a structure of a blockchain-based event processing apparatus, according to one or more embodiments of this specification. As shown in FIG. 6, the apparatus is applied to a blockchain node, a first smart contract for performing event processing and a second smart contract for managing participant resources are deployed on the blockchain node, and the apparatus includes: a request receiving module 602, configured to receive an event processing request initiated by an event initiator, where the event processing request includes an event processing parameter; a resource determining module 604, configured to parse, when verification performed on the event processing parameter based on the first smart contract is passed, the event processing parameter based on the first smart contract, determine an event participant, invoke the second smart contract, and determine a current remaining resource of the event participant; a resource freezing module 606, configured to invoke, when the current remaining resource of the event participant satisfies an event processing condition, the second smart contract based on the first smart contract, and freeze an event resource needed for processing the event processing request in the current remaining resource of the event participant; and an event processing module 608, configured to invoke, when a confirmation instruction of the event participant for the event processing parameter of the event processing request is received, the second smart contract based on the first smart contract, deduct the event resource, and complete the event processing request.

Optionally, the resource determining module 604 is further configured to: verify the event processing parameter based on the first smart contract; parse, when the verification is passed, the event processing parameter based on the first smart contract, and determine at least one event participant for processing the event processing request; and invoke the second smart contract based on the first smart contract, and determine a current remaining resource of each event participant.

Optionally, the apparatus further includes a first updating module, configured to update an event state of the first smart contract to an event processing parameter confirmation complete state.

Optionally, the resource freezing module 606 is further configured to: determine an event processing resource for processing the event processing request by each event participant based on the event processing parameter; and invoke, when it is determined that a current remaining resource of each event participant is greater than or equal to the event processing resource, the second smart contract based on the first smart contract, and freeze an event resource needed for processing the event processing request by each event participant in the current remaining resource of each event participant.

Optionally, the apparatus further includes a second updating module, configured to update, when it is determined that a current remaining resource of any event participant is less than the event processing resource, an event state of the first smart contract to an event processing failure state, and end the event processing request.

Optionally, the apparatus further includes a third updating module, configured to update an event state of the first smart contract to a state of waiting for each event participant to confirm and process the event processing request.

Optionally, the apparatus further includes a query request receiving module, configured to receive an event query request sent by the event participant for the event processing request, and return an event processing parameter for processing the event processing request to the event participant based on the event query request.

The event query request is sent by the event participant after the event participant monitors and parses block content of the blockchain node to determine the corresponding event processing request.

Optionally, the event processing module 608 is further configured to: query and determine, when a confirmation instruction of any event participant for the event processing parameter of the event processing request is received, whether each event participant sends a confirmation instruction for the event processing parameter; and if yes, invoke the second smart contract based on the first smart contract, deduct a frozen event resource of each event participant, and complete the event processing request.

Optionally, the apparatus further includes a fourth updating module, configured to update an event state of the first smart contract to an event processing request processing success state.

Optionally, the apparatus further includes a query request receiving module, configured to receive a current processing state query request sent by the event initiator and/or the event participant for the event processing request, and return a current processing state for the event processing request to the event initiator and/or the event participant based on the current processing state query request.

Optionally, the apparatus further includes a fifth updating module, configured to invoke an update interface of the second smart contract, and update the current remaining resource of each event participant based on a resource update rule of each event participant in the second smart contract.

Optionally, the apparatus further includes a rule updating module, configured to: receive a rule update request initiated by the event participant by invoking the update interface of the second smart contract, where the rule update request includes a rule update parameter; and update the resource update rule based on the rule update parameter when verification performed on the rule update parameter based on the second smart contract is passed.

According to the blockchain-based event processing apparatuses provided in the embodiments of this specification, the first smart contract and the second smart contract are automatically bound, and the event processing request on the blockchain is automatically advanced by using the first smart contract and the second smart contract, to process the event processing request. In addition, the validity of the event participant and limit information of the event participant are automatically analyzed on the blockchain, so that the event processing request can be correspondingly processed in a timely manner based on an analysis result, the event processing speed can be increased, and the processing timeliness can be ensured.

The previous descriptions are example solutions of the blockchain-based event processing apparatuses in the embodiments. It is worthwhile to note that the technical solutions of the blockchain-based event processing apparatuses pertain to the same concept as the technical solutions of the previously described blockchain-based event processing methods. For details not described in detail in the technical solutions of the blockchain-based event processing apparatuses, references can be made to the descriptions of the technical solutions of the previously described blockchain-based event processing methods.

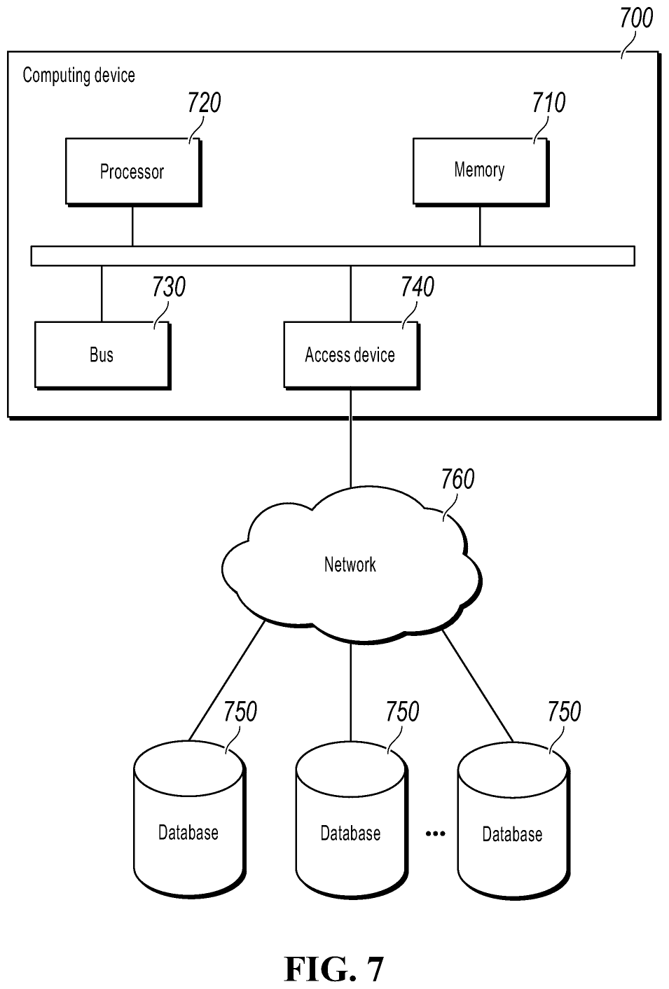

FIG. 7 is a block diagram illustrating a structure of a computing device 700 according to one or more embodiments of this specification. Components of the computing device 700 include but are not limited to a memory 710 and a processor 720. The processor 720 is connected to the memory 710 through a bus 730, and a database 750 is configured to store data.

The computing device 700 further includes an access device 740, and the access device 740 enables the computing device 700 to communicate via one or more networks 760. Examples of such networks include a public switched telephone network (PSTN), a local area network (LAN), a wide area network (WAN), a personal area network (PAN), or a combination of communication networks such as the Internet. The access device 740 can include one or more of any type of wired or wireless network interface (for example, a network interface card (NIC)), for example, an IEEE 802.11 wireless local area network (WLAN) wireless interface, a Worldwide Interoperability for Microwave Access (WiMAX) interface, an Ethernet interface, a Universal Serial Bus (USB) interface, a cellular network interface, a Bluetooth interface, or a near field communication (NFC) interface.

In one or more embodiments of this specification, the previous components of the computing device 700 and other components not shown in FIG. 7 can also be connected to each other, for example, through a bus. It should be understood that the block diagram illustrating the structure of the computing device shown in FIG. 7 is for purposes of example only and is not intended to limit the scope of this specification. Other components can be added or substituted as desired by a person skilled in the art.

The computing device 700 can be any type of stationary or mobile computing device, including a mobile computer or a mobile computing device (for example, a tablet computer, a personal digital assistant, a laptop computer, a notebook computer, or a netbook), a mobile phone (for example, a smartphone), a wearable computing device (for example, a smart watch or smart glasses), another type of mobile computing device, or a stationary computing device such as a desktop computer or a PC. Alternatively, the computing device 700 can be a mobile or stationary server.

The processor 720 is configured to execute computer-executable instructions, and when the computer-executable instructions are executed by the processor, the steps of the previously described blockchain-based event processing method are implemented.

The previous descriptions are example solutions of the computing devices in the embodiments. It is worthwhile to note that the technical solutions of the computing devices pertain to the same concept as the technical solutions of the previously described blockchain-based event processing methods. For details not described in detail in the technical solutions of the computing devices, references can be made to the descriptions of the technical solutions of the previously described blockchain-based event processing methods.

One or more embodiments of this specification further provide a computer-readable storage medium. The computer-readable storage medium stores computer-executable instructions, and when the computer-executable instructions are executed by a processor, the steps of the previously described blockchain-based event processing method are implemented.

The previous descriptions are example solutions of the computer-readable storage mediums in the embodiments. It is worthwhile to note that the technical solutions of the storage mediums pertain to the same concept as the technical solutions of the previously described blockchain-based event processing methods. For details not described in detail in the technical solutions of the storage mediums, references can be made to the descriptions of the technical solutions of the previously described blockchain-based event processing methods.

One or more embodiments of this specification further provide a computer program. When the computer program is executed on a computer, the computer is enabled to perform the steps of the previously described blockchain-based event processing method.

The previous descriptions are example solutions of the computer program in the embodiments. It is worthwhile to note that the technical solutions of the computer programs pertain to the same concept as the technical solutions of the previously described blockchain-based event processing methods. For details not described in detail in the technical solutions of the computer programs, references can be made to the descriptions of the technical solutions of the previously described blockchain-based event processing methods.

Specific embodiments of this specification are described above. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing is feasible or can be advantageous.

The computer instructions include computer program code, and the computer program code may be in the form of source code, object code, an executable file, some intermediate forms, etc. The computer-readable medium can include any entity or apparatus capable of including computer program code, a recording medium, a USB flash disk, a removable hard disk, a magnetic disk, an optical disk, a computer memory, a read-only memory (ROM), a random access memory (RAM), an electrical carrier signal, a telecommunications signal, a software distribution medium, etc. It is worthwhile to note that the content of the computer-readable medium can be appropriately incremented or decremented in accordance with the demands of legislation and patent practice within jurisdictions. For example, in some jurisdictions, the computer-readable medium does not include the electrical carrier signal or the telecommunications signal in accordance with legislation and patent practice.

It is worthwhile to note that to make the description brief, the previously described method embodiments are expressed as a combination of a series of actions. However, a person skilled in the art should appreciate that the embodiments of this specification are not limited to the described action sequence because some steps can be performed in other sequences or performed simultaneously according to the embodiments of this specification. In addition, a person skilled in the art should also appreciate that all the embodiments described in this specification are examples of embodiments, and the actions and modules mentioned are not necessarily mandatory to the embodiments of this specification.

In the previously described embodiments, the description of each embodiment has respective focuses. For a part not described in detail in an embodiment, references can be made to related descriptions in other embodiments.

The examples of the embodiments of this specification disclosed above are merely intended to help describe this specification. The optional embodiments do not describe all details in detail, and this application is not limited to the specific implementations. Clearly, many modifications and changes can be made based on the content of the embodiments of this specification. These embodiments are selected and described in detail in this specification to better explain principles and practical applications of the embodiments of this specification, so that a person skilled in the art can better understand and use this specification. This specification is limited only by the claims and all the scope and equivalents thereof.

What is claimed is:

1. A computer-implemented method for blockchain-based event processing, comprising:
receiving an event processing request initiated by an event initiator, wherein the event processing request comprises an event processing parameter;
parsing, when verification performed on the event processing parameter based on a first smart contract is passed, the event processing parameter based on the first smart contract, determining an event participant, invoking a second smart contract, and determining a current remaining resource of the event participant, wherein the first smart contract is used performing event processing and the second smart contract is used for managing participant resources, and wherein the first smart contract and the second smart contract are deployed on a blockchain node;
invoking, when the current remaining resource of the event participant satisfies an event processing condition, the second smart contract based on the first smart contract, and freezing an event resource needed for processing the event processing request in the current remaining resource of the event participant; and
invoking, when a confirmation instruction of the event participant for the event processing parameter of the event processing request is received, the second smart contract based on the first smart contract, deducting the event resource, and completing the event processing request.

2. The computer-implemented method of claim 1, wherein parsing, when verification performed on the event processing parameter based on the first smart contract is passed, the event processing parameter based on the first smart contract, determining an event participant, invoking the second smart contract, and determining a current remaining resource of the event participant, comprises:
verifying the event processing parameter based on the first smart contract;
parsing, when the verification is passed, the event processing parameter based on the first smart contract, and determining at least one event participant for processing the event processing request.

3. The computer-implemented method of claim 2, comprising:
invoking the second smart contract based on the first smart contract, and determining a current remaining resource of each event participant.

4. The computer-implemented method of claim 3, wherein, after determining at least one event participant for processing the event processing request:
updating an event state of the first smart contract to an event processing parameter confirmation complete state.

5. The computer-implemented method of claim 3, wherein invoking, when the current remaining resource of the event participant satisfies an event processing condition, the second smart contract based on the first smart contract, and freezing an event resource needed for processing the event processing request in the current remaining resource of the event participant, comprises:
determining an event processing resource for processing the event processing request by each event participant based on the event processing parameter.

6. The computer-implemented method of claim 5, comprising:
invoking, when it is determined that a current remaining resource of each event participant is greater than or equal to the event processing resource, the second smart contract based on the first smart contract, and freezing an event resource needed for processing the event processing request by each event participant in the current remaining resource of each event participant.

7. The computer-implemented method of claim 6, wherein, after determining an event processing resource for processing the event processing request by each event participant based on the event processing parameter:
updating, when it is determined that a current remaining resource of any event participant is less than the event processing resource, an event state of the first smart contract to an event processing failure state, and ending the event processing request.

8. The computer-implemented method of claim 6, wherein, after invoking the second smart contract based on the first smart contract, and freezing an event resource needed for processing the event processing request by each event participant in the current remaining resource of each event participant:
updating an event state of the first smart contract to a state of waiting for each event participant to confirm and process the event processing request.

9. The computer-implemented method of claim 1, wherein, before invoking the second smart contract based on the first smart contract, deducting the event resource, and completing the event processing request:
receiving an event query request sent by the event participant for the event processing request, and returning an event processing parameter for processing the event processing request to the event participant based on the event query request, wherein after, by the event participant and to determine a corresponding event processing request, block content of the blockchain node is monitored and parsed, the event query request is sent by the event participant.

10. The computer-implemented method of claim 3, wherein invoking, when a confirmation instruction of the event participant for the event processing parameter of the event processing request is received, the second smart contract based on the first smart contract, deducting the event resource, and completing the event processing request, comprises:
querying and determining, when a confirmation instruction of any event participant for the event processing parameter of the event processing request is received, whether each event participant sends a confirmation instruction for the event processing parameter.

11. The computer-implemented method of claim 10, comprising:
invoking, in response to determining that each event participant sends the confirmation instruction for the event processing parameter, the second smart contract based on the first smart contract, deducting a frozen event resource of each event participant, and completing the event processing request.

12. The computer-implemented method of claim 11, wherein, after completing the event processing request:
updating an event state of the first smart contract to an event processing request processing success state.

13. The computer-implemented method of claim 1, wherein, after completing the event processing request:
receiving a current processing state query request sent by the event initiator or the event participant for the event processing request.

14. The computer-implemented method of claim 13, comprising:
returning a current processing state for the event processing request to the event initiator or the event participant based on the current processing state query request.

15. The computer-implemented method of claim 3, wherein, after completing the event processing request:
invoking an update interface of the second smart contract.

16. The computer-implemented method of claim 15, comprising:
updating the current remaining resource of each event participant based on a resource update rule of each event participant in the second smart contract.

17. The computer-implemented method of claim 16, comprising:
receiving a rule update request initiated by the event participant by invoking the update interface of the second smart contract, wherein the rule update request comprises a rule update parameter.

18. The computer-implemented method of claim 17, comprising:
updating the resource update rule of each event participant in the second smart contract based on the rule update parameter when verification performed on the rule update parameter based on the second smart contract is passed.

19. A non-transitory, computer-readable medium storing one or more instructions executable by a computer system to perform operations, comprising:
receiving an event processing request initiated by an event initiator, wherein the event processing request comprises an event processing parameter;
parsing, when verification performed on the event processing parameter based on a first smart contract is passed, the event processing parameter based on the first smart contract, determining an event participant, invoking a second smart contract, and determining a current remaining resource of the event participant, wherein the first smart contract is used performing event processing and the second smart contract is used for managing participant resources, and wherein the first smart contract and the second smart contract are deployed on a blockchain node;
invoking, when the current remaining resource of the event participant satisfies an event processing condition, the second smart contract based on the first smart contract, and freezing an event resource needed for processing the event processing request in the current remaining resource of the event participant; and
invoking, when a confirmation instruction of the event participant for the event processing parameter of the event processing request is received, the second smart contract based on the first smart contract, deducting the event resource, and completing the event processing request.

20. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
receiving an event processing request initiated by an event initiator, wherein the event processing request comprises an event processing parameter;
parsing, when verification performed on the event processing parameter based on a first smart contract is passed, the event processing parameter based on the first smart contract, determining an event participant, invoking a second smart contract, and determining a current remaining resource of the event participant, wherein the first smart contract is used performing event processing and the second smart contract is used for managing participant resources, and wherein the first smart contract and the second smart contract are deployed on a blockchain node;
invoking, when the current remaining resource of the event participant satisfies an event processing condition, the second smart contract based on the first smart contract, and freezing an event resource needed for processing the event processing request in the current remaining resource of the event participant; and
invoking, when a confirmation instruction of the event participant for the event processing parameter of the event processing request is received, the second smart contract based on the first smart contract, deducting the event resource, and completing the event processing request.
